(19) United States
(12) Patent Application Publication
(10) Pub. No.: US 2012/0005587 A1
(43) Pub. Date: Jan. 5, 2012

(54) Performing Remoting Operations For Different Regions Of A Display Surface At Different Rates

(76) Inventors: Robert P Martin, Fort Collins, CO (US); Gregory M. Hughes, Fort Collins, CO (US); Roland M. Hochmuth, Fort Collins, CO (US)

(21) Appl. No.: 13/203,975

(22) PCT Filed: Mar. 24, 2009
(86) PCT No.: PCT/US2009/038139

§ 371 Date: Aug. 30, 2011

(51) Int. Cl. G06F 3/00

(52) U.S. Cl. 715/740

(57) ABSTRACT

In accordance with at least some embodiments, a method performed by at least one processor includes generating boundaries for a first region and a second region of a display surface. The method also includes performing remoting operations for the first region at a first rate and performing remoting operations for the second region at a second rate. The first and second rates are different.

### BACKGROUND

Graphics applications generate image frames for display on a local or remote computer monitor. The amount of change between subsequent image frames may be great or small. For example, the amount of change may vary depending on how much of each image frame corresponds to still images (e.g., text or fixed graphics) and how much of each image frame corresponds to moving images (e.g., animated graphics or video). Updating the content on a remote computer monitor screen typically involves various resource consuming operations referred to herein as “remoting operations.” Unfortunately, remoting operations demand a considerably amount of resources (e.g., network bandwidth, memory bandwidth, and processor cycles).

### BRIEF DESCRIPTION OF THE DRAWINGS

For a detailed description of exemplary embodiments of the invention, reference will now be made to the accompanying drawings in which:

FIG. 1 shows a display surface management technique in accordance with embodiments of the disclosure;

FIG. 2 shows a system in accordance with embodiments of the disclosure;

FIG. 3 shows a remote graphics system in accordance with embodiments of the disclosure;

FIG. 4 shows various components of the remote graphics system of FIG. 3 in accordance with embodiments of the disclosure;

FIG. 5 shows a method in accordance with embodiments of the disclosure; and

FIG. 6 shows another method in accordance with embodiments of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described herein, embodiments of the disclosure reduce resource consumption, when updating content on a computer monitor's screen, by partitioning (sub-dividing) a display surface into multiple regions and performing remoting operations (e.g., “GRAB” operations, “COMPARE” operations, and “SEND” operations) for the different partitions at different rates. As used herein, “display surface” refers to a memory representation of a computer monitor's screen (i.e., each pixel of the screen is represented in memory). As used herein, a GRAB operation refers to reading at least some of an image frame from the display surface. As used herein, a COMPARE operation refers to comparing a current image frame with a previous image frame. As used herein, a SEND operation refers to transmitting image frame updates to a remote computer monitor. In some embodiments, a SEND operation includes compressing the image frame updates. The techniques described herein were developed for use in a remote graphics environment in which a “sender” system transmits graphics content to one or more remote “receiver” systems. However, these techniques are not limited to any particular embodiment and are applicable to any system with a graphic user interface (GUI).

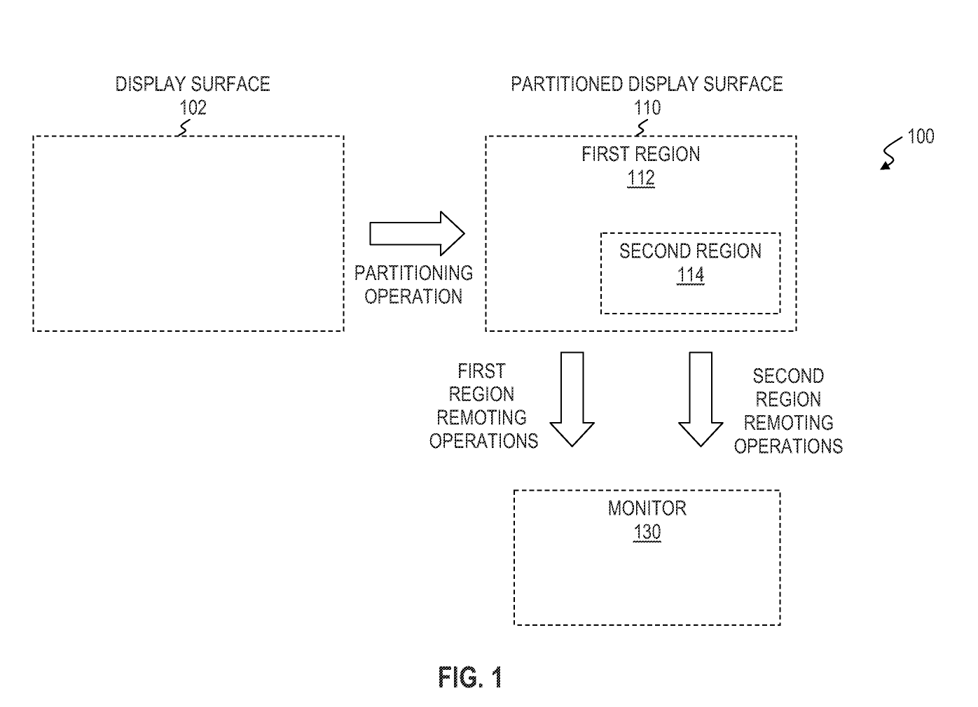

FIG. 1 shows a display surface management technique 100 in accordance with embodiments of the disclosure. As shown, a display surface 102 becomes a partitioned display surface 110 based on a partitioning operation. The partitioning operation defines at least a first region 112 and a second region 114 in the partitioned display surface 110. In at least some embodiments, the first region 112 and the second region 114 are defined by predetermined information regarding the content to be displayed. For example, predetermined information regarding the location of still images (e.g., text or fixed graphics) and moving images (e.g., animated graphics or video) in the content to be displayed may be used to define the first region 112 and the second region 114. This predetermined information may be obtained, for example, from prior knowledge of windows that will be displayed during execution of a given graphic application. In accordance with embodiments, the first region 112 corresponds to fixed or slow moving content and the second region 114 corresponds to fast moving content. As used herein, ‘movement’ of content refers to objects that change position from one frame to another relative to other objects in the frames.

In alternative embodiments, the first region 112 and the second region 114 are defined by “learned” information regarding the content to be displayed. The learned information identifies still (or slow moving) content and fast moving content by tracking the amount of display surface change that occurs over time. As an example, a tracking algorithm may keep a history for each of a plurality of display surface sub-blocks (e.g., the entire display surface may be divided into sub-blocks, each representing 8×8 pixels or another size). “High-motion” sub-blocks are those having more than a threshold amount of change over a predetermined amount of image frames (e.g., over 10 frames, the average number of pixels that change per frame is more than half the pixels in the sub-block). Upon detection, high-motion sub-blocks are preferably assigned to the second region 114. Meanwhile, “low-motion” sub-blocks are those having less than a threshold amount of change over the predetermined amount of image frames. Upon detection, low-motion sub-blocks are preferably assigned to the second region 114. In different embodiments, the threshold change amount, the history length tracked, and/or the size for the sub-blocks may vary. Further, the threshold change amount may consider color change thresholds as well (e.g., only color changes that are significant count as a change).

In at least some embodiments, sub-blocks are coalesced into larger blocks to form the second region 114. As an example, the second region 114 may correspond to the smallest rectangle that encompasses all of the detected high-motion sub-blocks. Alternatively, the second region 114 corresponds to multiple rectangles (joined or separated) of coalesced high-motion sub-blocks. In accordance with some embodiments, when relying on learned information, the shape and size of the second region 114 is dynamic and may vary over time.

Once the first region 112 and the second region 114 have been defined by the partitioning operation, the display surface management technique 100 performs first region remoting operations and second region remoting operations to update the content displayed on a computer monitor 130. In at least some embodiments, the remoting operations for both the first region 112 and the second region 114 comprise GRAB, COMPARE, and SEND operations as previously described. The frequency at which the first region remoting operations are performed differs from the frequency at which the second region remoting operations are performed. For example, the first region remoting operations may be performed at a predetermined update rate selected for fixed or slow-moving images (e.g., 1 to 5 frames per second) and the second region remoting operations may be performed at a predetermined update rate selected for fast-moving images (e.g., more than 20 frames per second).

Additionally or alternatively, for embodiments that rely on learned information to identify the first region 112 and the second region 114, the remoting operations rates assigned to each region may be customized and dynamic (e.g., based on an average amount of image change detected for the second region 114 and/or the first region 112). In other words, the region defining boundaries as well as each region's remoting operations rates may be selectively fixed or dynamic. As an example, predetermined default boundaries may be employed unless certain image change thresholds are surpassed (i.e., the image change thresholds indicate that the boundaries of the first region 112 and the second region 114 need to be adjusted). Similarly, predetermined default rates for remoting operations may be employed unless certain image change thresholds are surpassed (e.g., the image change thresholds indicate that the rates of remoting operations for the first region 112 and/or the second region 114 need to be adjusted).

In the display surface management technique 100 of FIG. 1 only two regions are described for the partitioned display surface 110. However, alternative embodiments may have three or more defined regions with different remoting operations rates. In such case, the regions and corresponding remoting operations rates may be predetermined or learned as previously described.

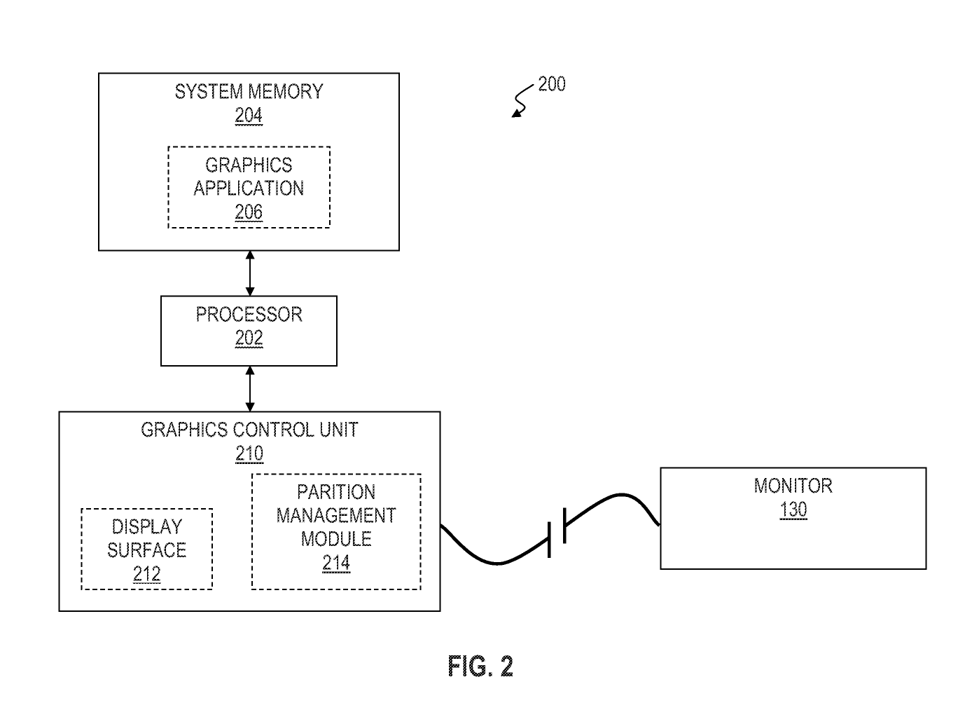

FIG. 2 shows a system 200 in accordance with embodiments of the disclosure. As shown, the system 200 comprises at least one processor 202 coupled to a system memory 204. The processor 202 corresponds to at least one of a variety of semiconductor devices such as microprocessors, microcontrollers, central processor units (CPUs), main processing units (MPUs), digital signal processors (DSPs), advanced reduced instruction set computing (RISC) machines, ARM processors, application specific integrated circuits (ASICs), field programmable gate arrays (FPGAs) or other processing devices. Although not required, the processor 202 may be a dedicated graphics processor. in general, the system memory 204 corresponds to a computer-readable medium that stores instructions/data and is read by electronic, magnetic, optical, electromagnetic, infrared, or other means. Examples of a computer-readable medium include a semiconductor or solid state memory, magnetic tape, a removable computer disk, a random access memory (RAM), a read-only memory (ROM), a rigid magnetic disk, and an optical disk (e.g., CD or DVD).

In FIG. 2, the system memory 204 stores at least one graphics application 206 for execution by the processor 202. Upon execution, the graphics application 206 stored by the system memory 204 generates image frames for display by a monitor 130. Rather than display generated image frames directly, the system 200 employs a graphics control unit 210 coupled between the processor 202 and the monitor 130 to process generated image frames and to update the content displayed on the monitor 130. In accordance with various embodiments, the monitor 130 may be a local component or a remote component of the system 200.

As shown, the graphics control unit 210 comprises a display surface 212, which is a memory representation of each pixel of the monitor's screen. The graphics control unit 210 also comprises a partition management module 214, which performs the display surface management technique 100 of FIG. 1. As an example, the partition management module 214 may represent hardware, firmware and/or software configured to partition the display surface 212 into different regions and to assign different rates for each region's remoting operations (e.g., GRAB, COMPARE and SEND). In embodiments in which the monitor 130 is a remote component, the SEND operation may comprise compressing and encrypting content for transmission to the monitor 130 via a network. By performing the display surface management technique 100, the graphics control unit 210 enables more efficient use of system resources (e.g., CPU cycles, memory bandwidth, and network bandwidth) compared to transmitting each full image frame directly to the monitor 130 or performing remoting operations (e.g., GRAB, COMPARE and SEND) for each full image frame.

Although the graphics control unit 210 of FIG. 2 is shown to comprise the display surface 212 and the partition management module 214, other embodiments are possible. For example, at least some of the display surface 212 may alternatively be stored in the system memory 204. Further, at least some of any software components of the partition management module 214 may alternatively be stored in the system memory 204. Such software components are stored by a computer-readable medium (e.g., part of the system memory 204 and/or the graphics control unit 210) for execution by the processor 202.

In at least some embodiments, the graphics control unit 210 and/or the system memory 204 stores instructions that, when executed, cause the processor 202 (or another processor) to generate boundaries for a first region and a second region of a display screen memory representation. For example, the instructions may cause the processor 202 to generate the boundaries based on predetermined information regarding content to be displayed on a display screen. Alternatively, the instructions may cause the processor 202 to dynamically generate the boundaries by tracking a history of content displayed on a display screen. The instructions further cause the processor 202 to assign a first rate to remoting operations associated with the first region and to assign a second rate to remoting operations associated with the second region. The first and second rates are different and are selected to in order to efficiently utilize system resources. In accordance with at least some embodiments, the instructions further cause the processor 202 to dynamically adjust at least one of the first rate and the second rate as needed to more efficiently utilize system resources,

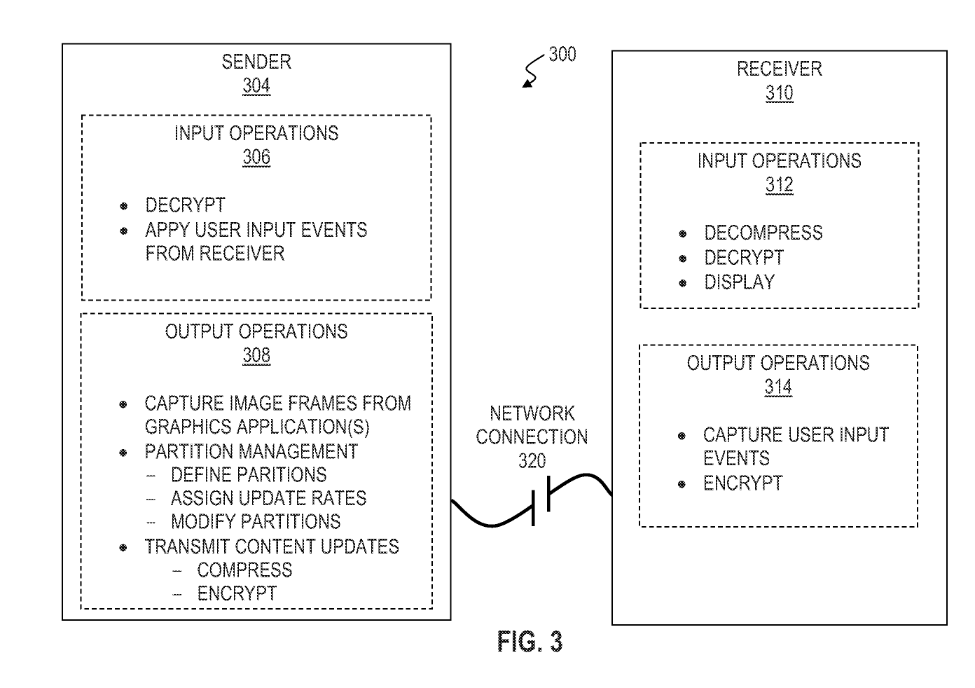

FIG. 3 shows a remote graphics system 300 in accordance with embodiments of the disclosure. The system 300 comprises a sender 304 and a receiver 310 of graphics content, where the sender 304 and the receiver 306 communicate via a network connection 320. The network connection 320 may be based on a local area network (LAN), a wide area network (WAN) (e.g., the Internet), or other network connections now known or later developed.

As shown, the sender 304 performs various input operations 306 and output operations 308. In at least some embodiments, the input operations 306 comprise decrypting and applying user input events from the receiver 310. For example, the user input events may correspond to keyboard commands, mouse commands, instructions received from a Universal Serial Bus (USB) device (e.g., a flash drive) or other user input events that originate at the receiver 310. Such user input events may affect, for example, which graphics application (or applications) is being executed by the sender 304 for use by the receiver 310. The user input events also may affect various options supported by each executed graphics application.

As shown, the output operations 308 comprise capturing image frames from at least one graphics application. The output operations 308 further comprise providing partition management of a display surface. As previously described for FIGS. 1 and 2, partition management includes defining partition boundaries within a display surface, assigning different content update rates to the different partitions and, if needed, modifying partitions. The output operations 308 also comprise transmitting graphics content updates to the receiver 310, which may include compressing and encrypting content for transmission to the receiver 310 via the network connection 320.

At the receiver 310, various input operations 312 and output operations 314 are performed. In at least some embodiments, the input operations 312 comprise decompressing, decrypting and displaying graphics content received from the sender 304. Meanwhile, the output operations 314 comprise capturing user input events (e.g., keyboard commands, mouse commands, voice commands, instructions received from a flash drive or a smart card, or other user input events) that originate at the receiver 310. The output operations 314 also may comprise encrypting captured user input user input events for transmission to the sender 304 via the network connection 320.

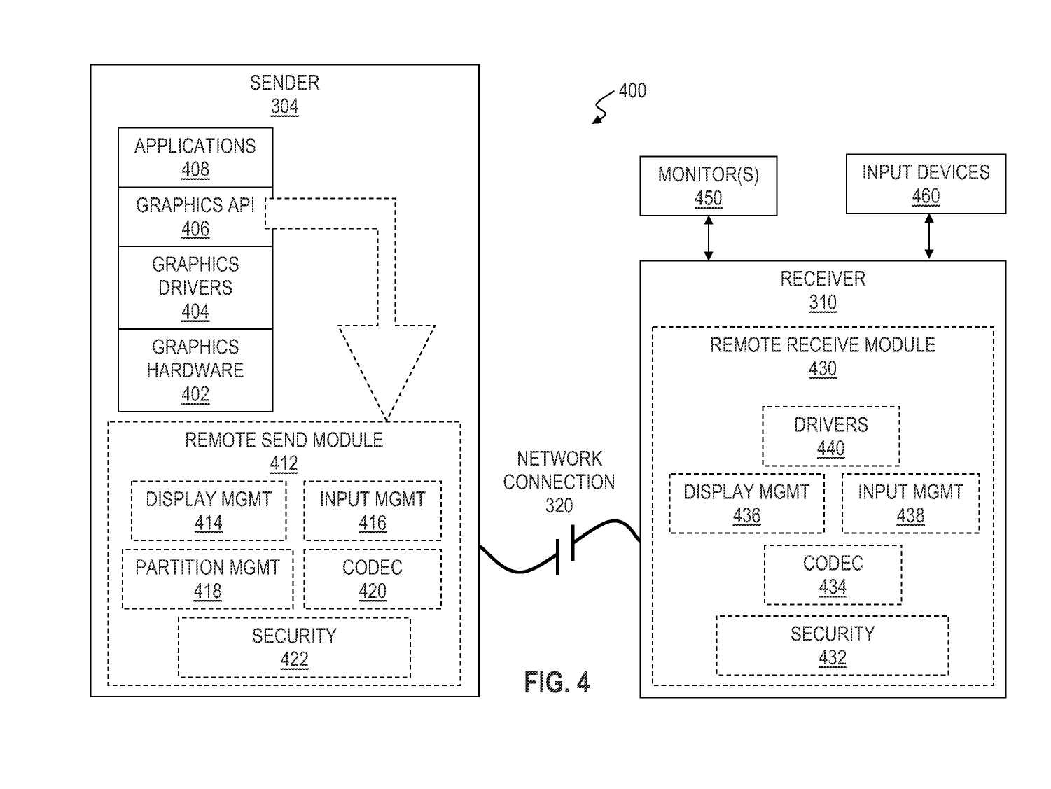

FIG. 4 shows various components of the remote graphics system 300 of FIG. 3 in accordance with embodiments of the disclosure. As shown, the sender 304 comprises graphics hardware 402, graphics drivers 404, a graphics applications programming interface (API) 406 and applications 408. In at least some embodiments, calls to the graphics API 406 are monitored (e.g., for Open GL and DirectX) to detect when changes to graphics content occur. Additionally or alternatively, a display surface (frame buffer) is periodically read to detect when changes to graphics content occur. Any changes are forwarded to a remote send module 412, which handles communications to and from the receiver 310.

In the embodiment of FIG. 4, the remote send module 412 comprises a display management component 414 that manages display options (e.g., resolution, color, or other options), an input management component 416 that manages user input events, a partition management component 418 that manages partitions as described herein, a CODEC (compression/decompression) component 420 that manages compression of content transmitted to the receiver 310. As an example, the CODEC component 420 may employ the “HP2” CODEC although other embodiments are possible. The remote send module 412 also comprises a security component 422 that manages encryption and decryption for the sender 304. The security component 304 also may authenticate users or otherwise limit access to the sender 304 as desired. In various embodiments, the sender 304 is part of a workstation or a blade server that provides enhanced graphics capabilities to one or more remote computers via the network connection 320.

As shown, the receiver 310 comprises a remote receive module 430, which handles communications to and from the sender 304. In at least some embodiments, the remote receive module 430 comprises a security component 432 that manages encryption and decryption for the receiver 310, a CODEC component 434 that manages decompression of content received from the second 304, a display management component 436 that manages display options (e.g., resolution, color, or other options) of at least one monitor 450 coupled to the receiver 310. The remote receive module 430 also comprises an input management component 438 that manages user input events received from input devices 460 (e.g., keyboard, mouse, or USB devices) coupled to the receiver 310. The remote receive module 430 also comprises drivers 440 to enable hardware components that are coupled to or are part of the receiver 310 to support the remote graphics technique described herein.

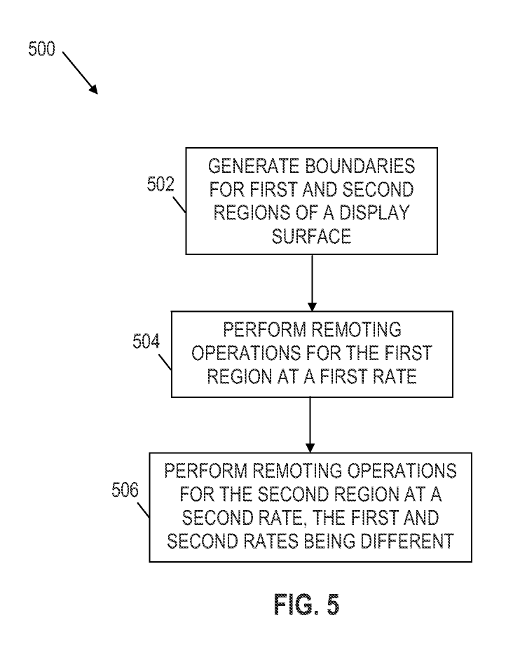

FIG. 5 shows a method 500 in accordance with embodiments of the disclosure. As shown, the method 500 comprises generating boundaries for a first region and a second region of a display surface (block 502). The method 500 also comprises performing remoting operations (e.g., GRAB, COMPARE, and SEND operations) for the first region at a first rate (block 504). The method 500 also comprises performing remoting operations for the second region at a second rate (block 506), where the first and second rates are different.

In accordance with at least some embodiments, the method 500 may comprise additional or fewer steps. As an example of additional steps, the method 500 may comprise generating boundaries for the first and second regions by accessing predetermined display surface information (e.g., information identifying the format/positioning of content to be displayed). Additionally, the method 500 may comprise dynamically modifying the boundaries of the first and second regions (e.g., by tracking content changes). Additionally, the method 500 may comprise selectively modifying the first rate and/or the second rate.

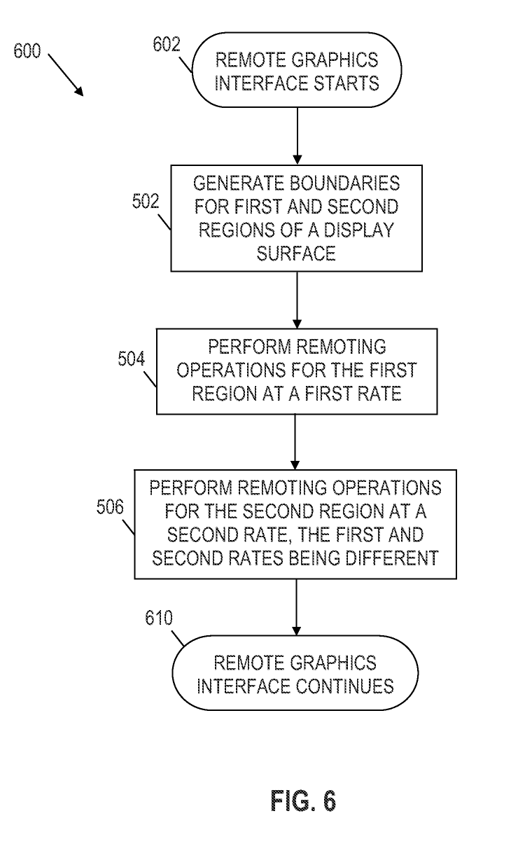

FIG. 6 shows another method 600 in accordance with embodiments of the disclosure. The method 600 performs the method 500 of FIG. 5 as part of a remote graphics interface. As shown, at block 602, the remote graphics interface starts. The method 500 is then performed (blocks 502, 504, 506) and the remote graphics interface continues at block 610. If desired, the additional steps mentioned for the method 500 also may be performed as part of a remote graphics interface.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, performed by at least one processor, comprising:
generating boundaries for a first region and a second region of a display surface;
performing remoting operations for the first region at a first rate; and
performing remoting operations for the second region at a second rate, the first and second rates being different.

2. The method of claim 1 wherein generating said boundaries comprises accessing predetermined display surface information.

3. The method of claim 1 further comprising dynamically modifying the boundaries of the first and second regions.

4. The method of claim 1 further comprising selectively modifying said first rate and selectively modifying said second rate.

5. The method of claim 1 wherein said generating boundaries, said performing remoting operations for the first region, and said performing remoting operations for the second region is performed by a sender unit in a remote graphics interface.

6. A computer system, comprising:
a processor;
a system memory that couples to the processor and stores a graphics application for execution by the processor;
a remote monitor screen for displaying content generated by the graphics application; and
a graphics control unit coupled to the processor and the remote monitor screen, the graphics control unit comprises a partition management module,
wherein the partition management module partitions a memory representation of the remote monitor screen into a first region and a second region,
wherein the partition management module causes remoting operations for the first region and the second region to be performed at different rates.

7. The computer system of claim 6 wherein the remoting operations comprise GRAB, COMPARE and SEND operations.

8. The computer system of claim 7 wherein the SEND operation comprises compressing and encrypting said content for transmission to the remote monitor screen via a network.

9. The computer system of claim 6 wherein the first and second regions are based on predetermined information regarding said content.

10. The computer system of claim 6 wherein the partition management module dynamically adjusts boundaries of the first and second regions.

11. A computer-readable medium storing instructions that, when executed, cause a processor to:
generate boundaries for a first region and a second region of a display screen memory representation;
assign a first rate to remoting operations associated with the first region; and
assign a second rate to remoting operations associated with the second region, the first and second rates being different.

12. The computer-readable medium of claim 11 wherein the instructions further cause the processor to generate said boundaries based on predetermined information regarding content to be displayed on a display screen.

13. The computer-readable medium of claim 11 wherein the instructions further cause the processor to dynamically modify the boundaries of the first and second regions.

14. The computer-readable medium of claim 13 wherein the instructions cause the processor to dynamically modify said boundaries by tracking a history of content displayed on a display screen.

15. The computer-readable medium of claim 11 wherein the instructions further cause the processor to dynamically adjust at least one of the first rate and the second rate.
